(19) United States
(12) Patent Application Publication
(10) Pub. No.: US 2008/0052712 A1
(43) Pub. Date: Feb. 28, 2008

(54) METHOD AND SYSTEM FOR SELECTING OPTIMAL CLUSTERS FOR BATCH JOB SUBMISSIONS

(75) Inventors: Martin B. Gustafson, Kasson, MN (US); Craig L. Kuhlman, Travelers Rest, SC (US); John R. Reysa, Austin, TX (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/466,509

(22) Filed: Aug. 23, 2006

(51) Int. Cl. G06F 9/46

(52) U.S. Cl. 718/101

(57) ABSTRACT

A method and system for selecting optimal clusters for batch job submissions is provided. The method includes receiving a job request for a class and determining a number of jobs waiting in a queue for the class at each of a group of batch clusters. The method also includes determining a number of job slots for each job class within each of the group of batch clusters. The method further includes calculating a ratio of the number of jobs waiting and the number of job slots for each of the group of batch clusters, the ratio reflecting a wait time. The method also includes selecting a batch cluster from the group with the lowest ratio and dispatching the job request to the batch cluster with the lowest ratio, the lowest ratio reflecting a shortest wait time.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to grid computing, and particularly to a method and system for determining optimal clusters for batch job submissions.

2. Description of Background

Before our invention, the process of queuing appropriate numbers of jobs for each cluster in a computing environment that runs multiple batch clusters (e.g., a load leveler) was a challenge. For example, one technique for submitting jobs utilizes separate job submitters for each cluster. This solution requires that a user specify the cluster to which a job should go. Another solution provides for the designation of work to a specific cluster. However, as the number of jobs assigned to a queue for a cluster is dynamically changing over time, the cluster selected by the user (or otherwise designated) may not be the appropriate choice (e.g., the cluster queue may have many jobs waiting to be processed in comparison to other available clusters).

What is needed, therefore, is a way to select an optimal cluster to submit a job when running multiple batch clusters so that the job will have the best chance of starting.

### SUMMARY OF THE INVENTION

The shortcomings of the prior art are overcome and additional advantages are provided through the provision of a method for selecting optimal clusters for batch job submissions. The method includes receiving a job request for a class and determining a number of jobs waiting in a queue for the class at each of a group of batch clusters. The method also includes determining a number of job slots for each job class within each of the group of batch clusters. The method further includes calculating a ratio of the number of jobs waiting and the number of job slots for each of the group of batch clusters, the ratio reflecting a wait time. The method also includes selecting a batch cluster from the group with the lowest ratio and dispatching the job request to the batch cluster with the lowest ratio, the lowest ratio reflecting a shortest wait time.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which uses static and dynamic data about clusters to identify and select an optimal cluster for submitting a job when running multiple batch clusters. An optimal cluster reflects one of a group of clusters that has the shortest wait time.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which cluster selection processes may be implemented in exemplary embodiments; and

FIG. 2 illustrates one example of a flow diagram describing a process for implementing cluster selection processes in exemplary embodiments.

The detailed description explains the preferred embodiments of the invention, together with advantages and features, by way of example with reference to the drawings.

### DETAILED DESCRIPTION OF THE INVENTION

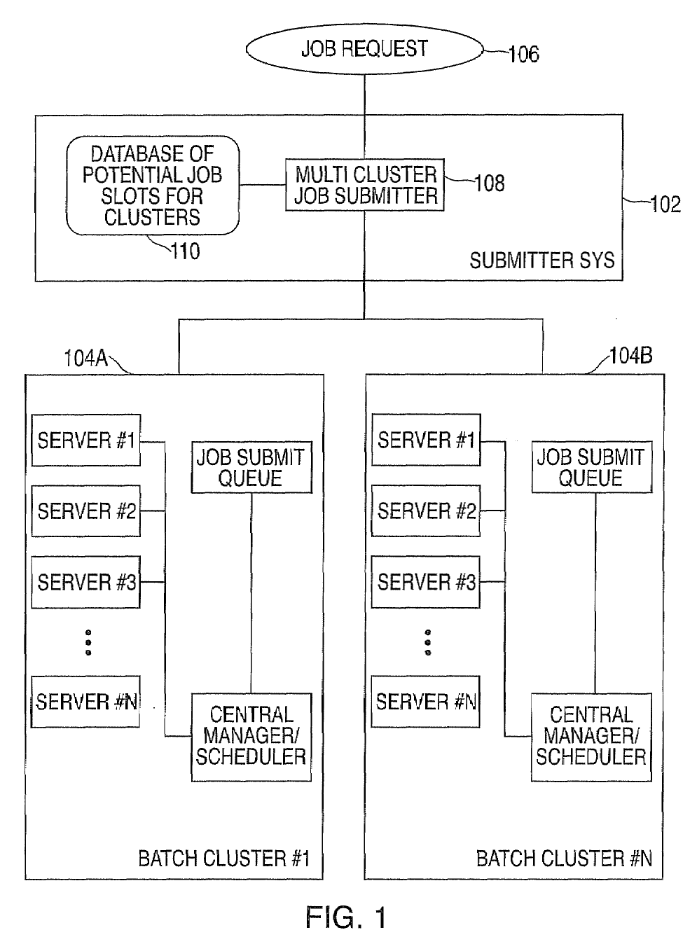

As indicated above, a cluster selection process uses static and dynamic data about clusters to identify and select an optimal cluster for submitting a job when rnmning multiple batch clusters. An optimal cluster reflects one of a group of clusters that is determined to have the shortest wait time. Turning now to the drawings in greater detail, it will be seen that in FIG. 1 there is a system upon which the cluster selection processes may be implemented in exemplary embodiments. The system of FIG. 1 includes a submitter system 102 executing a multi-cluster job submitter 108 and a database of potential job slots 110 for clusters to which jobs are assigned. The submitter system 102 may be implemented using any suitable computer processing device. The multi-cluster job submitter 108 receives job requests 106 for submission and processing by one of batch clusters 104A, 104B. For example, a job request may be a request to run a verification program against a particular engineering design. The request may, by default, request one CPU. The request may also contain the amount of memory the job will require as well as the class that the job should run in. Other parameters may also be specified in the job request. As shown in the system of FIG. 1, there are two batch clusters 104A and 104B. Batch clusters 104A, 104B refer to a grouping of processors (e.g., workstations) that cooperatively perform operations under the direction of a central manager, or scheduler, based upon requests from one or more users. Batch clusters 104A and 104B each include a job submit queue 112A, 112B, respectively, and a central manager/scheduler 114A, 114B. The job submit queue 112 holds job requests that are pending dispatch to one of servers 1-N. The central manager/schedule 114 reads the job submit queue 112, determines the priority of those jobs, and then matches the requirements of those jobs against what is available on the servers in the respective cluster (e.g., clusters 104A, 104B). The central manager/schedule 114 also assigns the job from the job submit queue 112 to a particular server (e.g., servers 1-N).

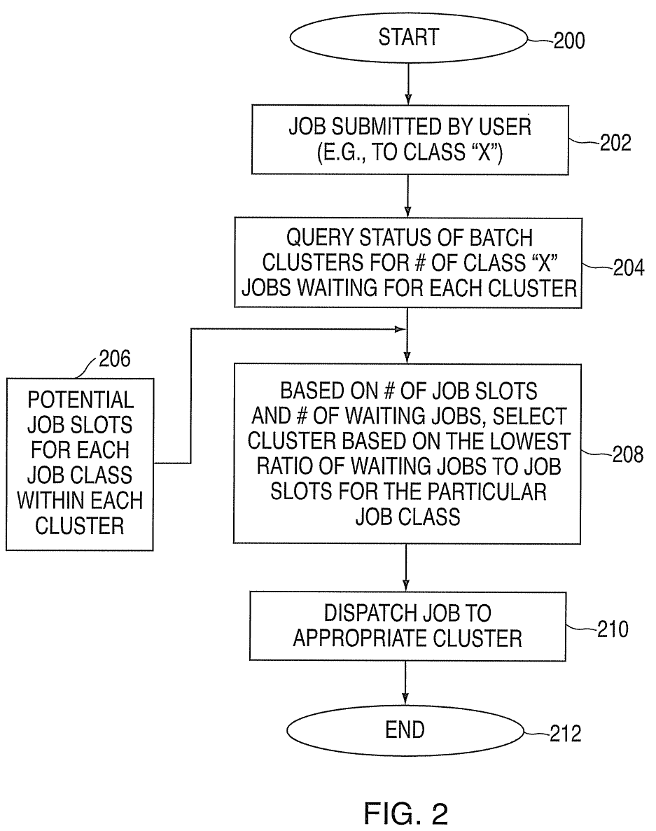

Turning now to FIG. 2, a process for implementing cluster selection will now be described in accordance with exemplary embodiments. The process begins at step 200 whereby a job request 106 is submitted by a user (e.g., manual submission) or is an automated function. The request may be for a specific class (e.g., Class A-N). The request is received at the multi-cluster job submitter 108 of submitter system 102.

The multi-cluster job submitter 108 queries each cluster (104A, 104B) for a status regarding the number of jobs for the requested class that are waiting at step 204. This number is dynamic. At step 206, the multi-cluster job submitter 108 identifies the potential job slots for each job class within each cluster (104A, 104B). This relates to the number of jobs that could potentially run concurrently for that same job class in each cluster and is a static number.

At step 208, the multi-cluster job submitter 108 calculates the ratio of job slots and corresponding waiting jobs for each cluster. The multi-cluster job submitter 108 selects the cluster with the lowest ratio value for the job request. At step 210, the job is dispatched to the cluster selected in step 208 and the process ends at step 212.

By way of example, suppose that at the time of query, cluster 104A has 1000 potential job slots for class X and 95 jobs waiting for class X. The ratio would be calculated as 95/1000, or 0.095. Suppose also that cluster 104B has 100 job slots for class X and 9 jobs waiting for class X. The ratio for cluster 104B would be calculated as 9/100, or 0.09. Cluster 104B would be selected by the multi-cluster job submitter 108 for submission. At this time, the jobs waiting for class X in cluster 104B is 10 (one job added to the queue of nine jobs). If another job request is submitted at this time, the ratio for cluster 104A is still 0.095; however, the ratio for cluster 104B is now 10/100, or 0.10. Thus, this second job request would be assigned to cluster 104A since its' ratio is lower than that of cluster 104B.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for selecting optimal clusters for batch job submissions, comprising:
receiving a job request for a class;
determining a number of jobs waiting in a queue for the class at each of a group of batch clusters;
determining a number of job slots for each job class within each of the group of batch clusters;
calculating a ratio of the number of jobs waiting and the number of job slots for each of the group of batch clusters, the ratio reflecting a wait time;
selecting a batch cluster from the group with the lowest ratio; and
dispatching the job request to the batch cluster with the lowest ratio, the lowest ratio reflecting a shortest wait time.

2. The method of claim 1, wherein the job request includes an amount of memory a job requires and a class to which the job will run.

3. The method of claim 1, wherein the number of job slots for each job class comprises a number of jobs that are capable of running concurrently for the job class.

4. A system for selecting optimal clusters for batch job submissions, comprising:
a submitter system; and
a multi-cluster job submitter application executing on the submitter system, the multi-cluster job submitter application performing a method, comprising:
receiving a job request for a class;
determining a number of jobs waiting in a queue for the class at each of a group of batch clusters;
determining a number of job slots for each job class within each of the group of batch clusters;
calculating a ratio of the number of jobs waiting and the number of job slots for each of the group of batch clusters, the ratio reflecting a wait time;
selecting a batch cluster from the group with the lowest ratio; and
dispatching the job request to the batch cluster with the lowest ratio, the lowest ratio reflecting a shortest wait time.

5. The system of claim 4, wherein the job request includes an amount of memory a job requires and a class to which the job will run.

6. The system of claim 4, wherein the number of job slots for each job class comprises a number of jobs that are capable of running concurrently for the job class.

7. A computer program product for selecting optimal clusters for batch job submissions, the computer program product including instructions for implementing a method, comprising:
receiving a job request for a class;
determining a number of jobs waiting in a queue for the class at each of a group of batch clusters;
determining a number of job slots for each job class within each of the group of batch clusters;
calculating a ratio of the number of jobs waiting and the number of job slots for each of the group of batch clusters, the ratio reflecting a wait time;
selecting a batch cluster from the group with the lowest ratio; and
dispatching the job request to the batch cluster with the lowest ratio, the lowest ratio reflecting a shortest wait time.

8. The computer program product of claim 7, wherein the job request includes an amount of memory a job requires and a class to which the job will run.

9. The computer program product of claim 7, wherein the number of job slots for each job class comprises a number of jobs that are capable of running concurrently for the job class.
